(19) United States
(12) Patent Application Publication
(10) Pub. No.: US 2004/0186863 A1
(43) Pub. Date: Sep. 23, 2004

(54) Elision of write barriers for stores whose values are in close proximity

(76) Inventor: Alexander T. Garthwaite, Beverly, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/394,813

(22) Filed: Mar. 21, 2003

(51) Int. Cl. G06F 17/30

(52) U.S. Cl. 707/206

(57) ABSTRACT

The present invention provides a technique for reducing the number of write barriers executed in mutator code without compromising garbage collector performance or correctness. Since garbage collectors typically scan a heap (or a portion of a heap) for reachable objects during their collection intervals, most collectors do not need to be notified of reference-writing instructions unless the instructions add new reachable objects to the heap. According to the illustrative embodiment, certain compile-time tests can be performed that, if passed, guarantee that the reference modification in question will make no otherwise unreachable object reachable. One or more of these tests is performed and no write barrier is emitted by the compiler for a given reference-writing instruction if the instruction passes such a test. For example, a compiler does not emit write-barrier code corresponding to mutator instructions that write a self-reference into an object reference field or copy a reference value from one object reference field to another located in the same object or card. By excluding such unnecessary write barrier overhead, the mutator may execute faster and more efficiently.

### FIELD OF THE INVENTION

The present invention is directed to memory management. It particularly, concerns what has come to be known as “garbage collection.”

### BACKGROUND OF THE INVENTION

In the field of computer systems, considerable effort has been expended on the task of allocating memory to data objects. For the purposes of this discussion, the term object refers to a data structure represented in a computer system's memory. Other terms sometimes used for the same concept are record and structure. An object may be identified by a reference, a relatively small amount of information that can be used to access the object. A reference can be represented as a “pointer” or a “machine address,” which may require, for instance, only sixteen, thirty-two, or sixty-four bits of information, although there are other ways to represent a reference.

In some systems, which are usually known as “object oriented,” objects may have associated methods, which are routines that can be invoked by reference to the object. They also may belong to a class, which is an organizational entity that may contain method code or other information shared by all objects belonging to that class. In the discussion that follows, though, the term object will not be limited to such structures; it will additionally include structures with which methods and classes are not associated.

The invention to be described below is applicable to systems that allocate memory to objects dynamically. Not all systems employ dynamic allocation. In some computer languages, source programs can be so written that all objects to which the program's variables refer are bound to storage locations at compile time. This storage-allocation approach, sometimes referred to as “static allocation,” is the policy traditionally used by the Fortran programming language, for example.

Even for compilers that are thought of as allocating objects only statically, of course, there is often a certain level of abstraction to this binding of objects to storage locations. Consider the typical computer system 100 depicted in FIG. 1, for example. Data, and instructions for operating on them, that a microprocessor 110 uses may reside in on-board cache memory or be received from further cache memory 120, possibly through the mediation of a cache controller 130. That controller 130 can in turn receive such data from system read/write memory (“RAM”) 140 through a RAM controller 150 or from various peripheral devices through a system bus 160. Additionally, instructions and data may be received from other computer systems via a communication interface 180. The memory space made available to an application program may be “virtual” in the sense that it may actually be considerably larger than RAM 140 provides. So the RAM contents will be swapped to and from a system disk 170.

Additionally, the actual physical operations performed to access some of the most-recently visited parts of the process's address space often will actually be performed in the cache 120 or in a cache on board microprocessor 110 rather than on the RAM 140, with which those caches swap data and instructions just as RAM 140 and system disk 170 do with each other.

A further level of abstraction results from the fact that an application will often be run as one of many processes operating concurrently with the support of an underlying operating system. As part of that system's memory management, the application's memory space may be moved among different actual physical locations many times in order to allow different processes to employ shared physical memory devices. That is, the location specified in the application's machine code may actually result in different physical locations at different times because the operating system adds different offsets to the machine-language-specified location.

The use of static memory allocation in writing certain long-lived applications makes it difficult to restrict storage requirements to the available memory space. Abiding by space limitations is easier when the platform provides for dynamic memory allocation, i.e., when memory space to be allocated to a given object is determined only at run time.

Dynamic allocation has a number of advantages, among which is that the run-time system is able to adapt allocation to run-time conditions. For example, the programmer can specify that space should be allocated for a given object only in response to a particular run-time condition. The C-language library function malloc( ) is often used for this purpose. Conversely, the programmer can specify conditions under which memory previously allocated to a given object can be reclaimed for reuse. The C-language library function free( ) results in such memory reclamation. Because dynamic allocation provides for memory reuse, it facilitates generation of large or long-lived applications, which over the course of their lifetimes may employ objects whose total memory requirements would greatly exceed the available memory resources if they were bound to memory locations: statically.

Particularly for long-lived applications, though, allocation and reclamation of dynamic memory must be performed carefully. If the application fails to reclaim unused memory—or, worse, loses track of the address of a dynamically allocated segment of memory—its memory requirements will grow over time to exceed the system's available memory. This kind of error is known as a “memory leak.” Another kind of error occurs when an application reclaims memory for reuse even though it still maintains a reference to that memory. If the reclaimed memory is reallocated for a different purpose, the application may inadvertently manipulate the same memory in multiple inconsistent ways. This kind of error is known as a “dangling reference.”

A way of reducing the likelihood of such leaks and related errors is to provide memory-space reclamation in a more automatic manner. Techniques used by systems that reclaim memory space automatically are commonly referred to as garbage collection. Garbage collectors operate by reclaiming space that they no longer consider “reachable.” Statically allocated objects represented by a program's global variables are normally considered reachable throughout a program's life. Such objects are not ordinarily stored in the garbage collector's managed memory space, but they may contain references to dynamically allocated objects that are, and such objects are considered reachable. Clearly, an object referred to in the processor's call stack is reachable, as is an object referred to by register contents. And an object referred to by any reachable object is also reachable. As used herein, a call stack is a data structure corresponding to a process or thread (i.e., an application), whereby the call stack comprises a sequence of frames that store state information, such as register contents and program counter values, associated with nested routines within the process or thread.

The use of garbage collectors is advantageous because, whereas a programmer working on a particular sequence of code can perform his task creditably in most respects with only local knowledge of the application at any given time, memory allocation and reclamation require a global knowledge of the program. Specifically, a programmer dealing with a given sequence of code does tend to know whether some portion of memory is still in use for that sequence of code, but it is considerably more difficult for him to know what the rest of the application is doing with that memory. By tracing references from some conservative notion of a root set, e.g., global variables, registers, and the call stack, automatic garbage collectors obtain global knowledge in a methodical way. By using a garbage collector, the programmer is relieved of the need to worry about the application's global state and can concentrate on local-state issues, which are more manageable. The result is applications that are more robust, having no dangling references and fewer memory leaks.

Garbage collection mechanisms can be implemented by various parts and levels of a computing system. One approach is simply to provide them as part of a batch compiler's output. Consider FIG. 2's simple batch-compiler operation, for example. A computer system executes in accordance with compiler object code and therefore acts as a compiler 200. The compiler object code is typically stored on a medium such as FIG. 1's system disk 170 or some other machine-readable medium, and it is loaded into RAM 140 to configure the computer system to act as a compiler. In some cases, though, the compiler object code's persistent storage may instead be provided in a server system remote from the machine that performs the compiling. The electrical signals that carry the digital data by which the computer systems exchange that code are examples of the kinds of electromagnetic signals by which the computer instructions can be communicated. Others include radio waves, microwaves, and both visible and invisible light.

The input to the compiler is the application source code, and the end product of the compiler process is application object code. This object code defines an application 210, which typically operates on input such as mouse clicks, etc., to generate a display or some other type of output. This object code implements the relationship that the programmer intends to specify by his application source code. In one approach to garbage collection, the compiler 200, without the programmer's explicit direction, additionally generates code that automatically reclaims unreachable memory space.

Even in this simple case, though, there is a sense in which the application does not itself provide the entire garbage collector. Specifically, the application will typically call upon the underlying operating system's memory-allocation functions. And the operating system may in turn take advantage of various hardware that lends itself particularly to use in garbage collection. So even a very simple system may disperse the garbage collection mechanism over a number of computer system layers.

To get some sense of the variety of system components that can be used to implement garbage collection, consider FIG. 3's example of a more complex way in which various levels of source code can result in the machine instructions that a processor executes. In the FIG. 3 arrangement, the human applications programmer produces source code 310 written in a high-level language. A compiler 320 typically converts that code into “class files.” These files include routines written in instructions, called “byte codes” 330, for a “virtual machine” that various processors can be configured to emulate. This conversion into byte codes is almost always separated in time from those codes' execution, so FIG. 3 divides the sequence into a “compile-time environment” 300 separate from a “run-time environment” 340, in which execution occurs. One example of a high-level language for which compilers are available to produce such virtual-machine instructions is the Java™ programming language. (Java is a trademark or registered trademark of Sun Microsystems, Inc., in the United States and other countries.)

Most typically, the class files' byte-code routines are executed by a processor under control of a virtual-machine process 350. That process emulates a virtual machine from whose instruction set the byte codes are drawn. As is true of the compiler 320, the virtual-machine process 350 may be specified by code stored on a local disk or some other machine-readable medium from which it is read into FIG. 1's RAM 140 to configure the computer system to implement the garbage collector and otherwise act as a virtual machine. Again, though, that code's persistent storage may instead be provided by a server system remote from the processor that implements the virtual machine, in which case the code would be transmitted, e.g., electrically or optically to the virtual-machine-implementing processor.

In some implementations, much of the virtual machine's action in executing these byte codes is most like what those skilled in the art refer to as “interpreting,” so FIG. 3 depicts the virtual machine as including an “interpreter” 360 for that purpose. In addition to or instead of running an interpreter, many virtual-machine implementations actually compile the byte codes concurrently with the resultant object code's execution, so FIG. 3 depicts the virtual machine as additionally including a “just-in-time” compiler 370. The arrangement of FIG. 3 differs from FIG. 2 in that the compiler 320 for converting the human programmer's code does not contribute to providing the garbage collection function; that results largely from the virtual machine 350's operation.

Those skilled in that art will recognize that both of these organizations are merely exemplary, and many modern systems employ hybrid mechanisms, which partake of the characteristics of traditional compilers and traditional interpreters both. The invention to be described below is applicable independently of whether a batch compiler, a just-in-time compiler, an interpreter, or some hybrid is employed to process source code. In the remainder of this application, therefore, we will use the term compiler to refer to any such mechanism, even if it is what would more typically be called an interpreter.

Now, some of the functionality that source-language constructs specify can be quite complicated, requiring many machine-language instructions for their implementation. One quite-common example is a source-language instruction that calls for 64-bit arithmetic on a 32-bit machine. More germane to the present invention is the operation of dynamically allocating space to a new object; this may require determining whether enough free memory space is available to contain the new object and reclaiming space if there is not.

In such situations, the compiler may produce “inline” code to accomplish these operations. That is, all object-code instructions for carrying out a given source-code-prescribed operation will be repeated each time the source code calls for the operation. But inlining runs the risk that “code bloat” will result if the operation is invoked at many source-code locations.

The natural way of avoiding this result is instead to provide the operation's implementation as a procedure, i.e., a single code sequence that can be called from any location in the program. In the case of compilers, a collection of procedures for implementing many types of source-code-specified operations is called a runtime system for the language. The compiler and its runtime system are designed together so that the compiler “knows” what runtime-system procedures are available in the target computer system and can cause desired operations simply by including calls to procedures that the target system already contains. To represent this fact, FIG. 3 includes block 380 to show that the compiler's output makes calls to the runtime system as well as to the operating system 390, which consists of procedures that are similarly system resident but are not compiler-dependent.

Although the FIG. 3 arrangement is a popular one, it is by no means universal, and many further implementation types can be expected. Proposals have even been made to implement the virtual machine 350's behavior in a hardware processor, in which case the hardware itself would provide some or all of the garbage-collection function. In short, garbage collectors can be implemented in a wide range of combinations of hardware and/or software.

By implementing garbage collection, a computer system can greatly reduce the occurrence of memory leaks and other software deficiencies in which human programming frequently results. But it can also have significant adverse performance effects if it is not implemented carefully. To distinguish the part of the program that does “useful” work from that which does the garbage collection, the term mutator is sometimes used in discussions of these effects; from the collector's point of view, what the mutator does is mutate active data structures' connectivity.

Some garbage collection approaches rely heavily on interleaving garbage collection steps among mutator steps. In one type of garbage collection approach, for instance, the mutator operation of writing a reference is followed immediately by garbage collector steps used to maintain a reference count in that object's header, and code for subsequent new-object storage includes steps for finding space occupied by objects whose reference count has fallen to zero. Obviously, such an approach can slow mutator operation significantly.

Other approaches therefore interleave very few garbage collector-related instructions into the main mutator process but instead interrupt it from time to time to perform garbage-collection cycles, -in which the garbage collector finds unreachable objects and reclaims their memory space for reuse. Such an approach will be assumed in discussing FIG. 4's depiction of a simple garbage collection operation. Within the memory space allocated to a given application is a part 420 managed by automatic garbage collection. As used hereafter, all dynamically allocated memory associated with a process or-thread will be referred to as its heap. The logical organization and contents of a heap define its heap state. During the course of the application's execution, space is allocated for various objects 402, 404, 406, 408, and 410. Typically, the mutator allocates space within the heap by invoking the garbage collector, which at some level manages access to the heap. Basically, the mutator asks the garbage collector for a pointer to a heap region where it can safely place the object's data. The garbage collector keeps track of the fact that the thus-allocated region is occupied. It will refrain from allocating that region in response to any other request until it determines that the mutator no longer needs the region allocated to that object.

Garbage collectors vary as to which objects they consider reachable and unreachable. For the present discussion, though, an object will be considered “reachable” if it is referred to, as object 402 is, by a reference in a root set 400. The root set consists of reference values stored in the mutator's threads' call stacks, the central processing unit (CPU) registers, and global variables outside the garbage-collected heap. An object is also reachable if it is referred to, as object 406 is, by another reachable object (in this case, object 402). Objects that are not reachable can no longer affect the program, so it is safe to re-allocate the memory spaces that they occupy.

A typical approach to garbage collection is therefore to identify all reachable objects and reclaim any previously allocated memory that the reachable objects do not occupy. A typical garbage collector may identify reachable objects by tracing references from the root set 400. For the sake of simplicity, FIG. 4 depicts only one reference from the root set 400 into the heap 420. (Those skilled in the art will recognize that there are many ways to identify references, or at least data contents that may be references.) The collector notes that the root set points to object 402, which is therefore reachable, and that reachable object 402 points to object 406, which therefore is also reachable. But those reachable objects point to no other objects, so objects 404, 408, and 410 are all unreachable, and their memory space may be reclaimed.

To avoid excessive heap fragmentation, some garbage collectors additionally relocate reachable objects. FIG. 5 shows a typical approach for this “copying” type of garbage collection. The heap is partitioned into two halves, hereafter called “semi-spaces.” For one garbage-collection cycle, all objects are allocated in one semi-space 510, leaving the other semi-space 520 free. When the garbage-collection cycle occurs, objects identified as reachable are “evacuated” to the other semi-space 520, so all of semi-space 510 is then considered free. Once the garbage-collection cycle has occurred, all new objects are allocated in the lower semi-space 520 until yet another garbage-collection cycle occurs, at which time the reachable objects are evacuated back to the upper semi-space 510.

Although this relocation requires the extra steps of copying the reachable objects and updating references to them, it tends to be quite efficient, since most new objects quickly become unreachable, so most of the current semi-space is actually garbage. That is, only a relatively few, reachable objects need to be relocated, after which the entire semi-space contains only garbage and can be pronounced free for reallocation.

Now, a collection cycle can involve following all reference chains from the basic root set—i.e., from inherently reachable locations such as the call stacks, class statics and other global variables, and registers-and reclaiming all space occupied by objects not encountered in the process. And the simplest way of performing such a cycle is to interrupt the mutator to provide a collector interval in which the entire cycle is performed before the mutator resumes. For certain types of applications, this approach to collection-cycle scheduling is acceptable and, in fact, highly efficient.

For many interactive and real-time applications, though, this approach is not acceptable. The delay in mutator operation that the collection cycle's execution causes can be annoying to a user and can prevent a real-time application from responding to its environment with the required speed. In some applications, choosing collection times opportunistically can reduce this effect. For example, a garbage-collection cycle may be performed at a natural stopping point in the application, such as when the mutator awaits user input.

So it may often be true that the garbage-collection operation's effect on performance can depend less on the total collection time than on when collections actually occur. But another factor that often is even more determinative is the duration of any single collection interval, i.e., how long the mutator must remain quiescent at any one time. In an interactive system, for instance, a user may never notice hundred-millisecond interruptions for garbage collection, whereas most users would find interruptions lasting for two seconds to be annoying.

The cycle may therefore be divided up among a plurality of collector intervals. When a collection cycle is divided up among a plurality of collection intervals, it is only after a number of intervals that the collector will have followed all reference chains and be able to identify as garbage any objects not thereby reached. This approach is more complex than completing the cycle in a single collection interval; the mutator will usually modify references between collection intervals, so the collector must repeatedly update its view of the reference graph in the midst of the collection cycle. To make such updates practical, the mutator must communicate with the collector to let it know what reference changes are made between intervals.

An even more complex approach, which some systems use to eliminate discrete pauses or maximize resource-use efficiency, is to execute the mutator and collector in concurrent execution threads. Most systems that use this approach use it for most but not all of the collection cycle; the mutator is usually interrupted for a short collector interval, in which a part of the collector cycle takes place without mutation.

Independent of whether the collection cycle is performed concurrently with mutator operation, is completed in a single interval, or extends over multiple intervals is the question of whether the cycle is complete, as has tacitly been assumed so far, or is instead “incremental.” In incremental collection, a collection cycle constitutes only an increment of collection: the collector does not follow all reference chains from the basic root set completely. Instead, it concentrates on only a portion, or collection set, of the heap. Specifically, it identifies every collection-set object referred to by a reference chain that extends into the collection set from outside of it, and it reclaims the collection-set space not occupied by such objects, possibly after evacuating them from the collection set.

By thus culling objects referenced by reference chains that do not necessarily originate in the basic root set, the collector can be thought of as expanding the root set to include as roots some locations that may not be reachable. Although incremental collection thereby leaves “floating garbage,” it can result in relatively low pause times even if entire collection increments are completed during respective single collection intervals.

Most collectors that employ incremental collection operate in “generations” although this is not necessary in principle. Different portions, or generations, of the heap are subject to different collection policies. New objects are allocated in a “young” generation, and older objects are “promoted” from younger generations to older or more “mature” generations. Collecting the younger generations more frequently than the others yields greater efficiency because the younger generations tend to accumulate garbage faster; newly allocated objects tend to “die,” while older objects tend to “survive.”

But generational collection greatly increases what is effectively the root set for a given generation. Consider FIG. 6, which depicts a heap as organized into three generations 620, 640, and 660. Assume that generation 640 is to be collected. The process for this individual generation may be more or less the same as that described in connection with FIGS. 4 and 5 for the entire heap, with one major exception. In the case of a single generation, the root set must be considered to include not only the call stack, registers, and global variables represented by set 600 but also objects in the other generations 620 and 660, which themselves may contain references to objects in generation 640. So pointers must be traced not only from the basic root set 600 but also from objects within the other generations.

One could perform this tracing by simply inspecting all references in all other generations at the beginning of every collection interval, and it turns out that this approach is actually feasible in some situations. But it takes too long in other situations, so workers in this field have employed a number of approaches to expediting reference tracing. One approach is to include so-called write barriers in the mutator process. A write barrier is code added to a write operation in the mutator code to record information from which the garbage collector can determine where references were written or may have been since the last collection interval. The write-barrier code may communicate this information directly to the collector or indirectly through other runtime processes. A list of modified references can then be maintained by taking such a list as it existed at the end of the previous collection interval and updating it by inspecting only locations identified by the write barriers as possibly modified since the last collection interval.

One of the many write-barrier implementations commonly used by workers in this art employs what has been referred to as the “card table.” FIG. 6 depicts the various generations as being divided into smaller sections, known for this purpose as “cards.” Card tables 610, 630, and 650 associated with respective generations contain an entry for each of their cards. When the mutator writes a reference in a card, it makes an appropriate entry in the card-table location associated with that card (or, say, with the card in which the object containing the reference begins). Most write-barrier implementations simply make a Boolean entry indicating that the write operation has been performed, although some may be more elaborate. For example, assume reference 624 on card 622 is modified (“dirtied”) by the mutator, so a Boolean entry in corresponding card-table entry 605 may be set accordingly. The mutator having thus left a record of where new or modified references may be, the collector may scan the card-table to identify those cards in the mature generation that were marked as having been modified since the last collection interval, and the collector can scan only those identified cards for modified references.

Of course, there are other write-barrier approaches, such as simply having the write barrier add to a list of addresses where references were written. For instance, the list may be stored in a sequential-store buffer that is updated by write barriers in the mutator code. When the sequential-store buffer is filled, the mutator may be interrupted so a garbage collector can reclaim unused memory based on addresses in the buffer. At the end of such a collection interval, the buffer is cleared and the mutator resumes until it is interrupted again by the next garbage-collection interval.

Also, although there is no reason in principle to favor any particular number of generations, and although FIG. 6 shows three, most generational garbage collectors have only two generations, of which one is the young generation and the other is the mature generation. Moreover, although FIG. 6 shows the generations as being of the same size, a more-typical configuration is for the young generation to be considerably smaller. Further, each generation may be dispersed over various address ranges of memory instead of comprising a contiguous block of memory as shown in FIG. 6. Finally, although we assumed for the sake of simplicity that collection during a given interval was limited to only one generation, a more-typical approach is actually to collect the whole young generation at every interval but to collect the mature one less frequently.

Some collectors collect the entire young generation in every interval and may thereafter collect the mature generation collection in the same interval. It may therefore take relatively little time to scan all young-generation objects remaining after young-generation collection to find references into the mature generation. Even when such collectors do use card tables, therefore, they often do not use them for finding young-generation references that refer to mature-generation objects. On the other hand, laboriously scanning the entire mature generation for references to young-generation (or mature-generation) objects would ordinarily take too long, so write barriers are typically used to set card-table entries associated with the mature generation to thereby limit the amount of memory the collector searches for modified mature-generation references.

Write-barrier code is often inserted into mutator code in close proximity to a corresponding reference-writing mutator instruction. In an imprecise card-marking scheme, the write-barrier code marks the card-table entry that corresponds to the card in which a modified object begins. The collector responds to a dirty-card indication (i.e., a “marked” card) by locating objects that begin in the card, e.g., as indicated by the card's associated card-summarization information, and scanning all the reference fields in the located objects, even if some of the fields are located outside the card. The “coarseness” at which reference-field locations are summarized for the collector to scan defines the collector's region of summarization. For instance, in an imprecise card-marking scheme, the collector's region of summarization for a “dirty” card corresponds to the object reference fields contained in objects beginning in that card.

In a precise card-marking scheme, the write barrier marks the card-table entry that corresponds to the card in which a modified field is located. The collector responds to a dirty-card indication by examining the references located in the marked card. The collector then scans each of the located reference fields in the card, which defines the collector's region of summarization in the precise card-marking scheme. FIG. 7 illustrates exemplary write-barrier code for precise card-marking that corresponds to a mutator instruction that stores a reference value into an object reference field.

Cards, whether treated precisely or imprecisely, may be used by the collector to retain summarization information about the memory locations of references across collection intervals. For example, in their article entitled “Incremental Collection of Mature Objects,” Hudson et al. describe an incremental collection technique called the Train algorithm, wherein portions of the heap are individually collectible. To support this functionality, each portion maintains a remembered set recording memory locations in the heap that may refer to that portion. The entries in these remembered sets may advantageously be recorded as cards even if the write-barrier scheme used to communicate modified reference locations does not. In such cases, the region of summarization is still defined by the extent over which references are scanned by the collector.

FIG. 7's line N+1 contains an assembly instruction (STW) for storing a word-length value into an object reference field located at an offset C from the object's starting address, while lines N+3 through N+5 illustrate the assembly instruction's corresponding write-barrier code. In this example, the write barrier adds three instructions not originally present in the mutator code: ADD, Shift Right Logical (SRL) and Store Byte (STB) instructions. Specifically, the instruction at line N+3 stores the address of the modified object field in a “working” register, and the instruction at line N+4 divides this address by the card size to determine how many cards into the mature generation the modified field is located. Here, we have assumed the card size is 2^{M} bytes. Lastly, the instruction at line N+5 marks a card-table entry with a binary “0” corresponding to the card in the mature generation that stores the modified object field. As described, each card-table entry is assumed to have a length of one byte.

As seen with regards to FIG. 7, the inclusion of write barriers after modifying object references increases the amount of mutator code, e.g., by three instructions per reference modification. Clearly, this overhead may significantly increase the mutator's execution time, especially when the mutator code modifies references frequently. So adding write barriers to increase the garbage collector's efficiency tends to compromise the mutator's.

### SUMMARY OF THE INVENTION

The present invention provides a technique for reducing the number of write barriers executed in mutator code without compromising garbage collector performance. To that end, a compiler tests whether a reference-writing mutator instruction satisfies an elision criterion. The elision criterion is one that is met if the reference-writing instruction will result in a heap state in which scanning the written reference during any collection set's collection will not affect the ultimate determination of whether an object in that collection set is reachable.

One such criterion, for instance, is that the written reference value is one that cannot change the reachability of objects in the heap. One example is a reference-write instruction that causes the reference to refer to the object that contains the reference (i.e., a “self-reference”). In this case, the written reference cannot make any object reachable, so the collector does not have to consider it in determining any object's reachability. As a result, a write barrier need not accompany the reference-write instruction.

Another such criterion is that the heap is in a state in which an object reachable through the written reference is already reachable through some other reference. So long as that heap state prevails, there is no need for the collector to scan the written reference in determining the reachability of the referred-to object. In most cases, though, this would not relieve the mutator of the need to execute a write barrier, since a subsequent modification of that other reference may so change the heap state as to make the originally written reference's value again relevant to a reachability determination. But I have recognized that the mutator can safely forgo the write barrier if it can be shown that the write barrier accompanying such a subsequent modification of the other reference will have the effect of additionally notifying the collector of the originally written reference's value.

An example of such a situation is one that can arise when the collector employs so-called imprecise card marking. In imprecise card marking, execution of a write barrier marks a card-table entry corresponding to the card in which an object containing a modified reference begins, even if the modified reference is not itself in that card. The collector responds to a dirty-card indication by scanning all reference fields of the objects that begin in the card, even if some of the fields are located outside the card. If a reference is copied from a first reference field in an object to a second field in the same object, the compiler may safely omit the write barrier for the reference-write made to the second field. That is, execution of a write barrier corresponding to any subsequent modifications to the first object reference field will result in the collector scanning the entire object, thereby notifying the collector of the value that was written into the second reference field, whose modification was previously unrecorded.

Another example of such a situation is one that can arise when the collector employs so-called precise card marking. In precise card marking, execution of a write barrier marks a card-table entry corresponding to the card in which a modified reference is located. The collector responds to a dirty-card indication by scanning every reference field in the marked card. If a reference is copied from a first field to a second field located in the same card, the compiler may safely elide the write barrier for the reference-write made to the second reference field. That is, execution of a write barrier corresponding to any subsequent modifications to the first reference field will result in the collector scanning all reference fields in the card, thereby notifying the collector of the value that was written into the second reference field, whose modification was previously unrecorded.

### BRIEF DESCRIPTION OF THE DRAWINGS

The above and further advantages of the invention may be better understood by referring to the following description in conjunction with the accompanying drawings in which like reference numerals indicate identically or functionally similar elements, of which:

FIG. 1, previously discussed, is a schematic block diagram of a computer system of a type in which the present invention's teachings can be practiced;

FIG. 2, previously discussed, is a schematic block diagram illustrating a simple source-code compilation operation;

FIG. 3, previously discussed, is a schematic block diagram of a more complex compiler/interpreter organization;

FIG. 4, previously discussed, is a schematic block diagram that illustrates a basic garbage collection mechanism;

FIG. 5, previously discussed, is a schematic block diagram illustrating an the relocation operation of the garbage collection mechanism of FIG. 7;

FIG. 6, previously discussed, is a schematic block diagram that illustrates a garbage-collected heap's organization into generations;

FIG. 7, previously discussed, is an exemplary source code listing of a write barrier that may be used in accordance with the present invention;

FIG. 8 is a flowchart illustrating a sequence of steps that compile a source-code instruction into machine-level code;

FIG. 9 is a schematic block diagram of the result of executing the machine-level code generated in FIG. 8;

FIG. 10 is a flowchart illustrating a sequence of steps for compiling a mutator instruction that stores a self-reference in an object reference field;

FIG. 11 is a schematic block diagram of the result of executing the machine-level code generated in FIG. 10;

FIG. 12 is a flowchart illustrating a sequence of steps for compiling mutator instructions that use two local variables with the same value number to store a self-reference in an object reference field;

FIG. 13 is a schematic block diagram illustrating exemplary byte-code sequences that may be compiled by the compiler in FIG. 12;

FIG. 14 is a schematic block diagram of an exemplary table that maps value numbers assigned by the compiler as it compiles FIG. 13's byte-code representations;

FIG. 15 is a flowchart illustrating a sequence of steps for compiling mutator code where the mutator code may include instructions that store self-references in an object's reference fields;

FIG. 16 is a flowchart illustrating a sequence of steps for compiling a mutator instruction that stores a value located in a first object reference field into another field in the same object;

FIG. 17 is a schematic block diagram of the result of executing the machine-level code generated in FIG. 16;

FIG. 18 is a schematic block diagram of an exemplary table that maps memory locations to value numbers assigned by the compiler as it compiles FIG. 16's byte-code representations;

FIG. 19 is a schematic block diagram of an exemplary table that maps value numbers to equivalent object reference field locations as it compiles FIG. 16's byte-code representations in accordance with a precise card-marking scheme;

FIG. 20 is a flowchart illustrating a sequence of steps for compiling mutator instructions that use two objects with the same value number to store a value located in a first object reference field into another field in the same object;

FIG. 21 is a schematic block diagram illustrating exemplary byte-code sequences that may be compiled by the compiler in FIG. 20;

FIG. 22 is a schematic block diagram of an exemplary table that maps memory locations to value numbers assigned by the compiler as it compiles FIG. 21's byte-code representations;

FIG. 23 is a schematic block diagram of an exemplary table that maps value numbers to equivalent object reference field locations as it compiles FIG. 21's byte-code representations in accordance with a precise card-marking scheme;

FIG. 24 is a flowchart illustrating a sequence of steps for compiling mutator code where the mutator code may include instructions that store references located in an object/card into other reference fields located in the same object/card; and

FIG. 25 is a flowchart illustrating a sequence of steps for compiling mutator code that combines the techniques shown in FIGS. 15 and 24.

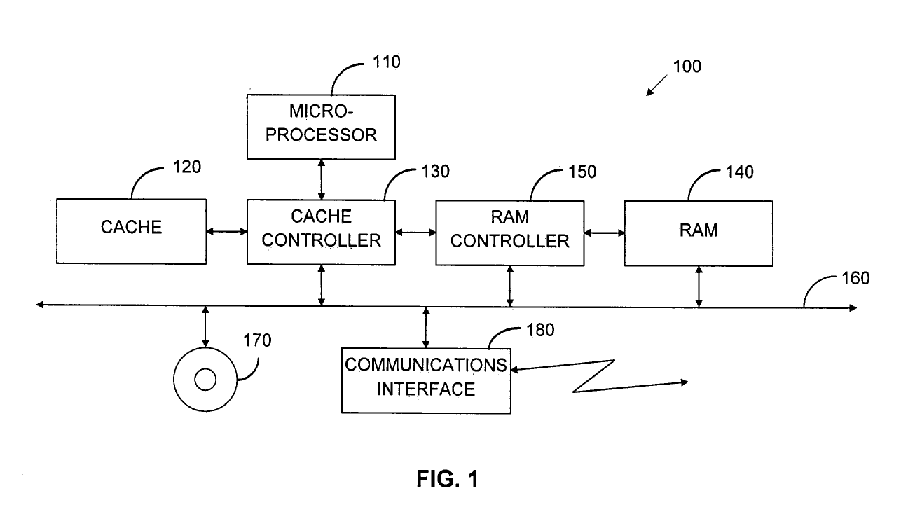

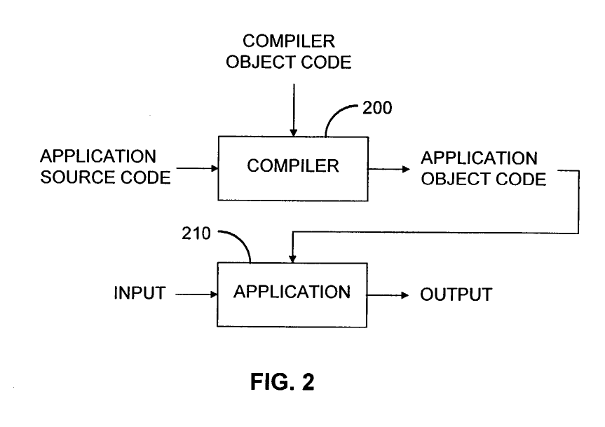

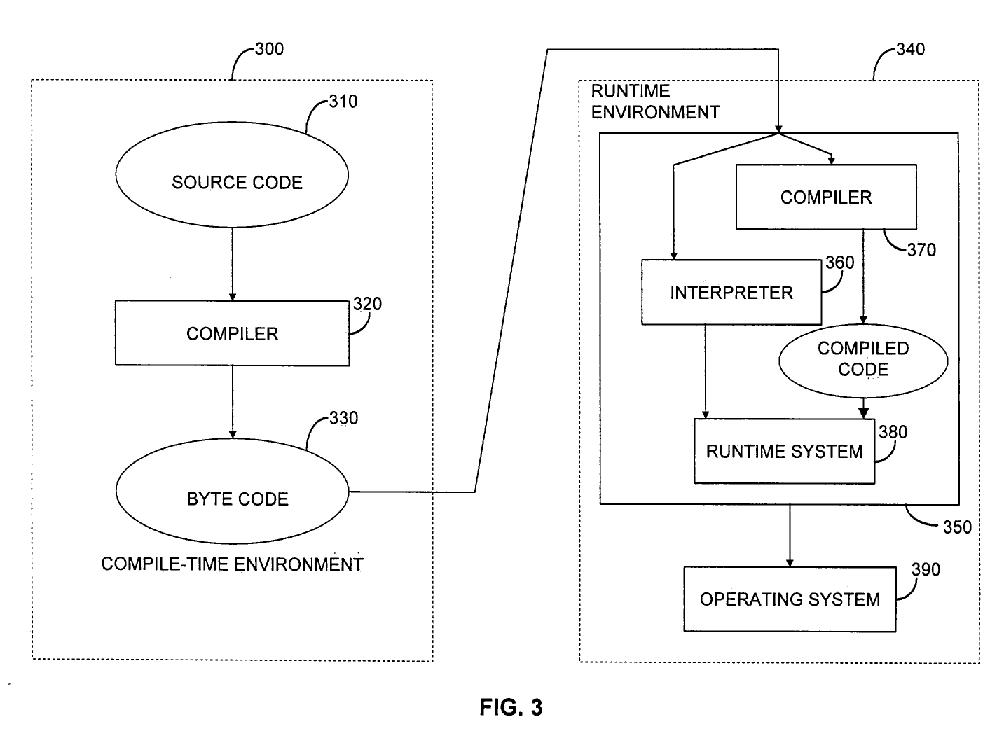

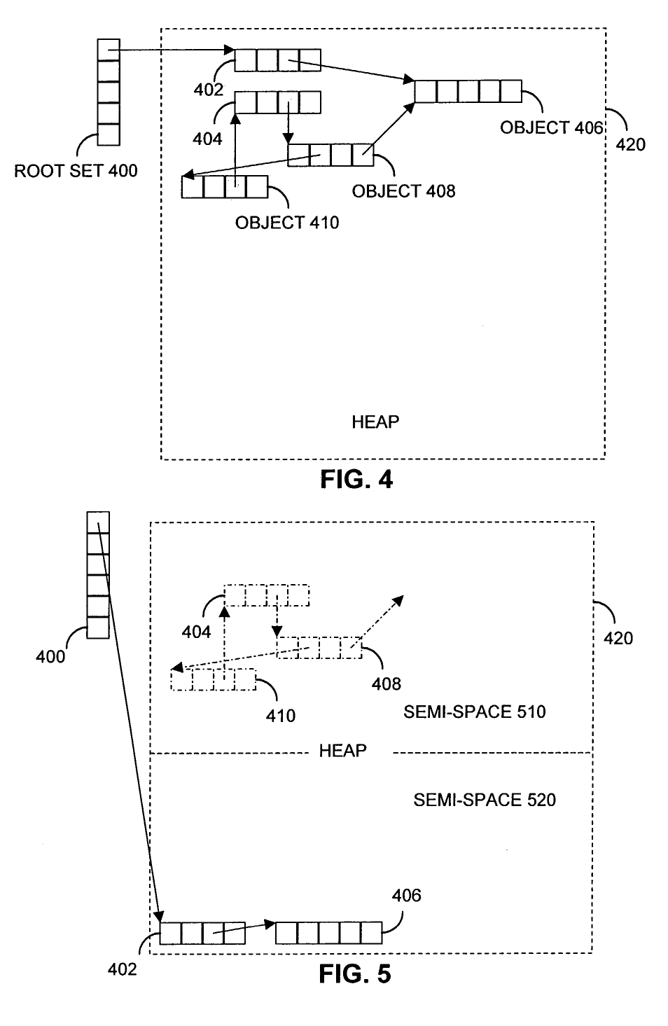

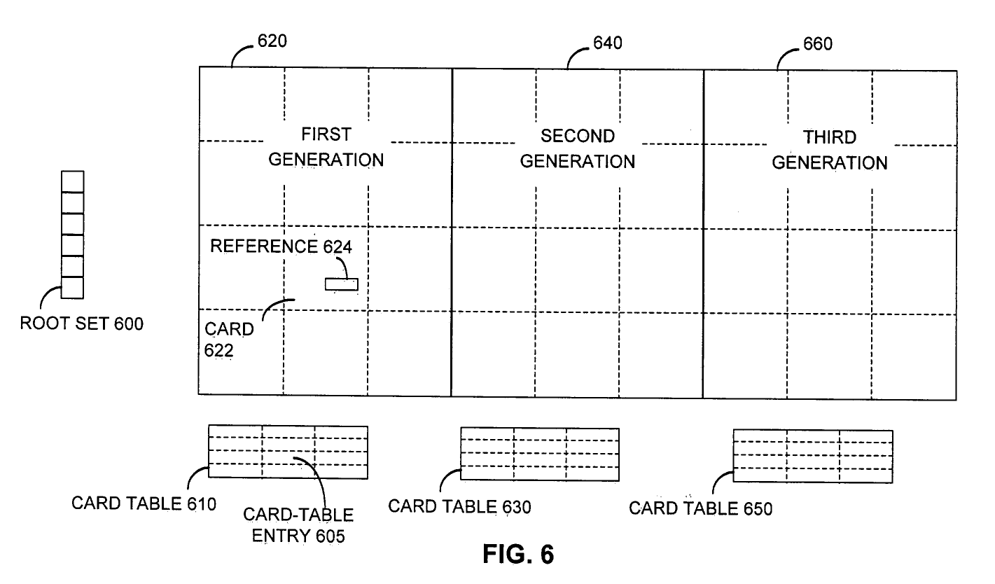

### DETAILED DESCRIPTION OF AN ILLUSTRATIVE EMBODIMENT

A. Compiling a Reference-Writing Instruction

A source-code instruction may write a reference value ref into a field f located in an object o, as follows:

o.f=ref;

Here, and throughout this disclosure, we wish to distinguish reference-writing instructions that can be statically proven by the compiler or interpreter to store NULL values or some other degenerate values into object reference fields from reference-writing instructions that may store actual reference values of objects into object reference fields. Our invention is concerned with this latter category of reference-writing instructions. In addition, objects described herein are broadly understood to include various object types, such as arrays. For instance, the source-code instruction “o.f=ref;” may be an array-write which is conventionally represented as “o[f]=ref;” without departing from the spirit and scope of this disclosure.

The source-code instruction above is compiled by, e.g., compiler 320, and converted into an intermediate-code representation, such as byte code, that is transferred to a virtual machine 350. As previously noted, the virtual-machine process may implement various interpreting and compiling functions, in combination with runtime-system and operating-system calls, to convert the received byte code into one or more machine-level instructions executable by a processor 110.

For ease of explanation hereinafter, assume the virtual machine compiles byte-code representations of reference-writing instructions using a compiler function Emit_WRITE. While the present invention will be described operationally in terms of this exemplary function, those skilled in the art will understand that one or more other interpreting, compiling, runtime-system and operating-system functions may alternatively be implemented without changing the inventive concepts set forth herein. The function Emit_WRITE requires arguments that enable it to identify the reference values being stored (i.e., the “source” values) and their corresponding destination addresses. For instance, in the case of storing the reference value ref in field f of object o, the compiler-function call may appear as:

Emit_WRITE (register_o, offset_f, register_ref)

where register_o stores the memory address of object o, offset_f identifies the location of a field f relative to the starting address of object o and register_ref stores the value ref which is typically a reference to another object. While not explicitly shown, the function may additionally take other arguments as well. The result of the exemplary Emit_WRITE function yields machine-level code (object code) that, when executed, stores the reference value ref in the field f. The assembly-language representation of this machine-level code may be shown as:

STW register_ref, (register_o+offset_f)

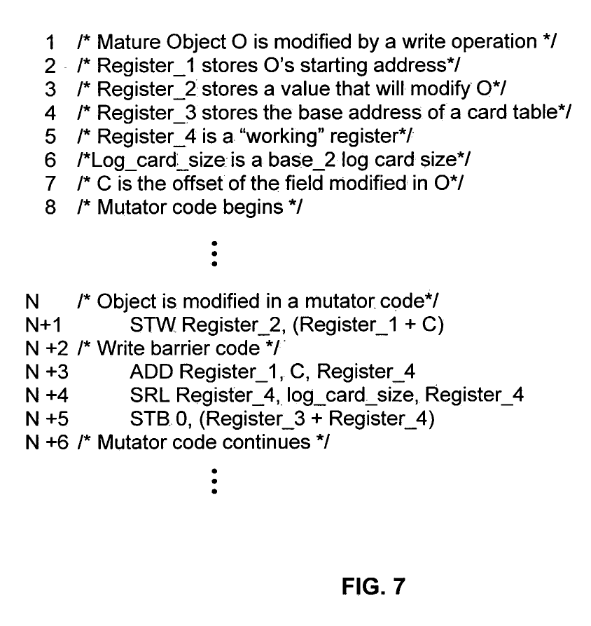

Furthermore, the compiler may emit a corresponding write barrier for this machine-level instruction, e.g., as illustrated in lines N+3 to N+5 of FIG. 7, depending on whether the instruction modifies a reference that results in a heap state in which scanning the modified reference during any collection set's collection will not affect the ultimate determination of whether an object in that collection set is reachable.

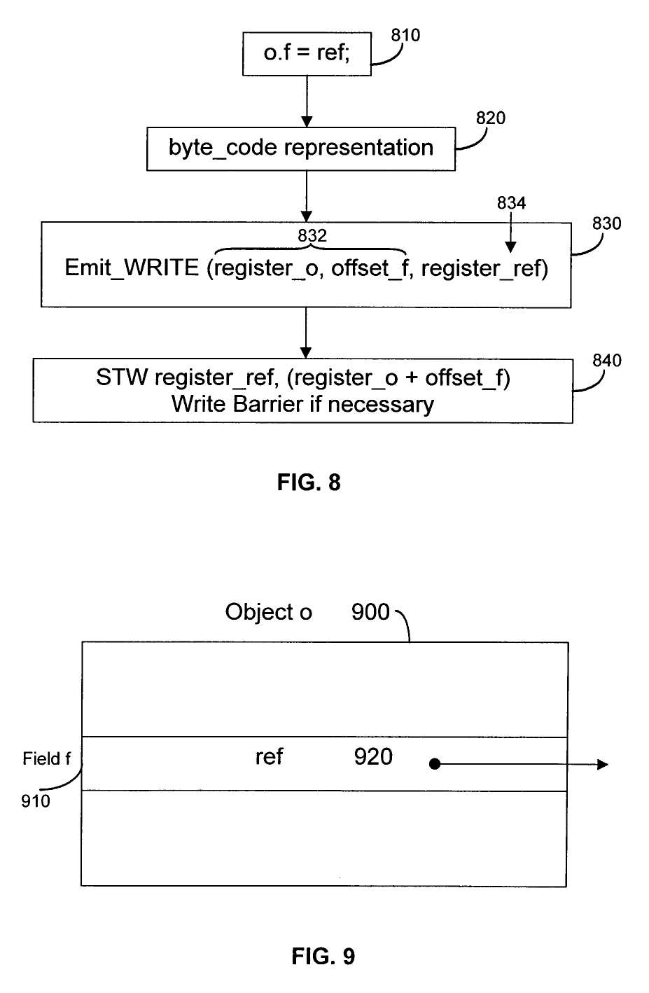

FIG. 8 summarizes the above-described compiling process for converting a reference-writing source-code instruction into machine-executable code. The source-code instruction 810 is converted to its byte-code representation 820, which is used, e.g., by a compiling process in a virtual machine, to formulate a compiler-function call 830. The compiler-function call comprises arguments 832 that identify a destination address and argument 834 that indicates the memory address in which the source value is stored. Upon executing the function, the compiler generates machine-level code 840 (shown in its assembler-language representation), including write-barrier code when necessary. The machine-level code and write-barrier code may then be executed by a processor or stored for future processing. FIG. 9 illustrates the result of executing the object code generated by the compiling process in FIG. 8. The reference value ref (920) is stored in field f (910) of object o (900).

B. Storing a Self-Reference in an Object Reference Field

The compiler does not necessarily emit a write barrier for each reference-writing instruction it compiles. According to the illustrative embodiment, the compiler tests reference-writing mutator instructions to determine whether any of them satisfy a criterion that can be satisfied only if execution of the mutator instruction will result in a heap state in which no scanning of the modified reference during any collection set's collection will affect the ultimate determination of whether an object in that collection set is reachable. If the criterion is satisfied, the compiler does not emit a write barrier corresponding to that reference-writing mutator instruction.

An example of such a criterion is that executing the instruction stores a reference to an object into a reference field of the same object. Since an instruction that stores a reference value in an object that serves as a “self-reference” cannot make additional memory reachable in the heap, a compiler may safely omit the instruction's corresponding write barrier from the mutator code. Notably, such self-reference instructions are often used to indicate “terminating” nodes in data structures, such as linked lists, trees and the like.

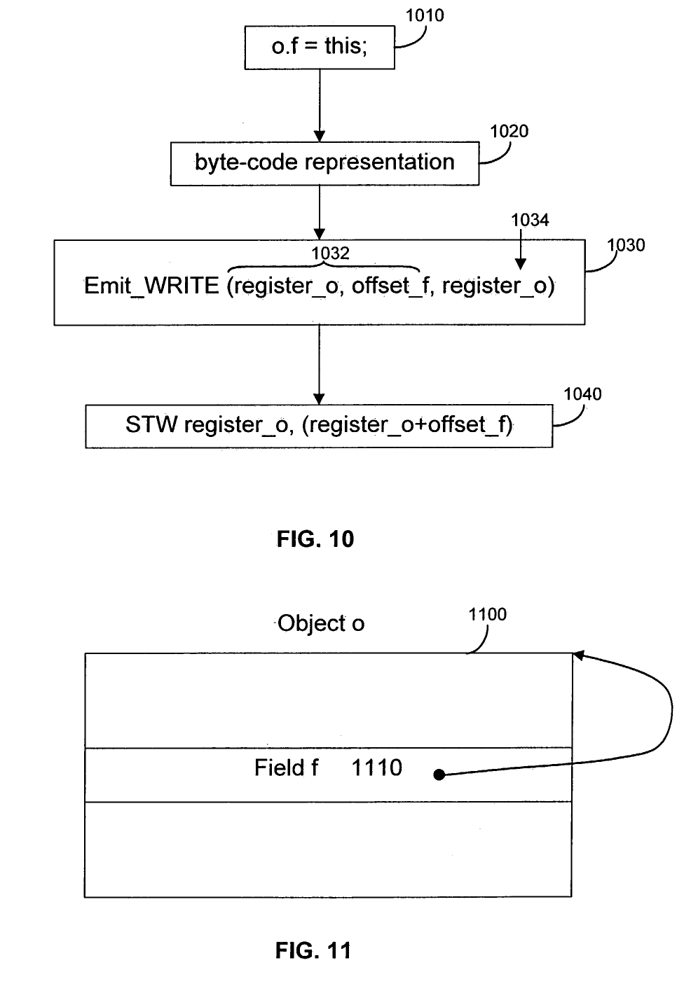

FIG. 10 depicts a sequence of steps for compiling an exemplary self-reference source-code instruction. More specifically, at step 1010, a field f of an object o is assigned the value of a “this”-pointer, which in this case stores the address of the object o. The source-code is converted to its byte-code representation, at step 1020, and a compiler process, e.g., in a virtual machine, formulates a compiler-function call 1030 to generate machine-level code 1040 (shown in its assembler-language representation) that may be executed by a processor. As in previous examples, register_o stores the starting address of object o and offset_f stores the relative offset of field f in object o.

The compiler function, e.g., Emit_WRITE, takes at least enough arguments to identify the reference value being stored and the reference's destination address. For instance, FIG. 10's exemplary compiler-function call 1030 comprises arguments 1032 specifying a destination address and argument 1034 identifying a memory address storing the source value being copied into the destination address. In the call 1030, the last argument indicates the source value being stored is the address contained in register_o, i.e., object o's “this”-pointer. The first argument shown indicates the destination address (i.e., field f) is also located in the object having the address stored in register_o. Therefore, by examining selected arguments of the Emit_WRITE function call, the compiler can identify the compiled instruction as storing a self-reference in the object o, and, in accordance with the illustrative embodiment, the compiler does not emit corresponding write-barrier code in addition to the STW (“store word”) instruction at step 1040. FIG. 11 illustrates the results of executing the generated object code of FIG. 10. Field f (1110) of object o (1100) stores the self-reference to the object o.

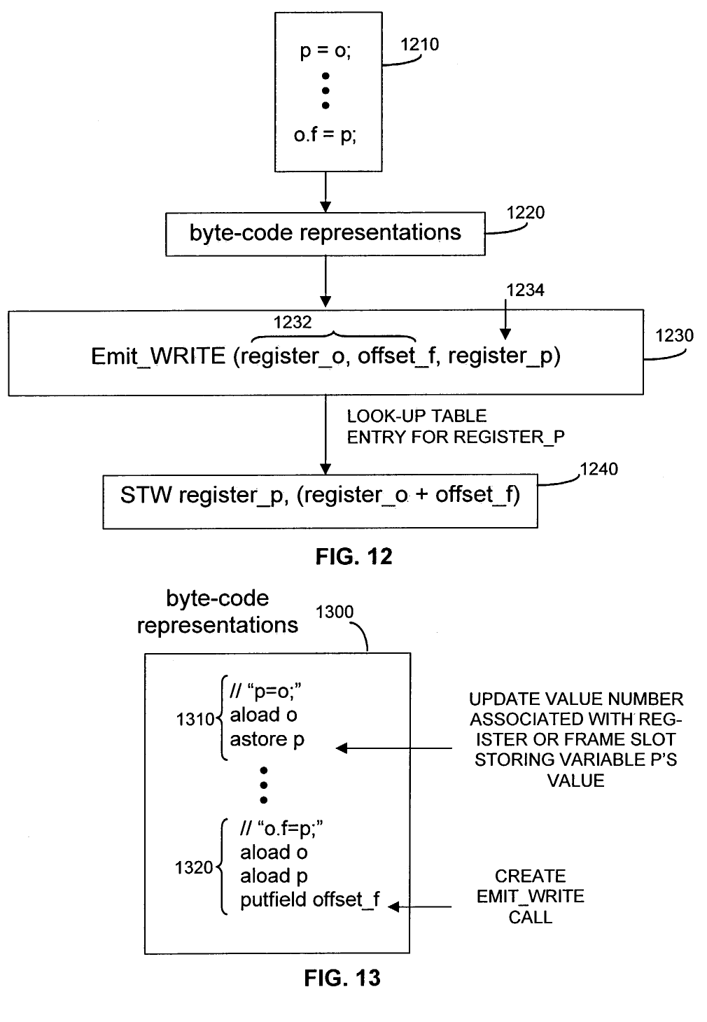

Typically, when compiling byte-codes or other intermediate representations of mutator code, a compiler associates a unique “value number” with every variable or expression that is assigned a value in the compiled code. For instance, in a simple case, byte-codes representing the source-code instruction “i=2;” result in the compiler's equating the value “2” with a unique value number associated with the variable i. In a more complex example, byte-codes representing the assignment “x=o.f+2;” result in the compiler's equating the value number for the object x with the addition of the reference value stored in field f of object o (“o.f”) and “2.” By correlating values numbers with their equivalent values and expressions, the compiler can perform simple substitutions that simplify computations and/or assignments in later-compiled code. Furthermore, the value numbers may also enable the compiler to identify certain types of mutator instructions, such as self-referencing instructions, that may not be immediately evident by their byte-code representations (as discussed below in regards to FIGS. 12-14).

FIG. 12 illustrates a sequence of steps for compiling mutator instructions that use a local variable p to store a self-reference in an object o. Source-code instructions, at step 1210, store a reference to the object o into the variable p (“p=o;”), then subsequently store the value of the variable p into a field f in the object o (“o.f=p;”). These two instructions need not be consecutive and may be separated by other instructions in the mutator code. The source-code instructions are converted to their byte-code representations, at step 1220, and are transferred to a compiler process, e.g., in a virtual-machine. FIG. 13 illustrates FIG. 12's byte-code representations in more detail. Specifically, the exemplary byte-codes 1300 are shown as two sequences 1310 and 1320, respectively corresponding to the instructions “p=o;” and “o.f=p;.”

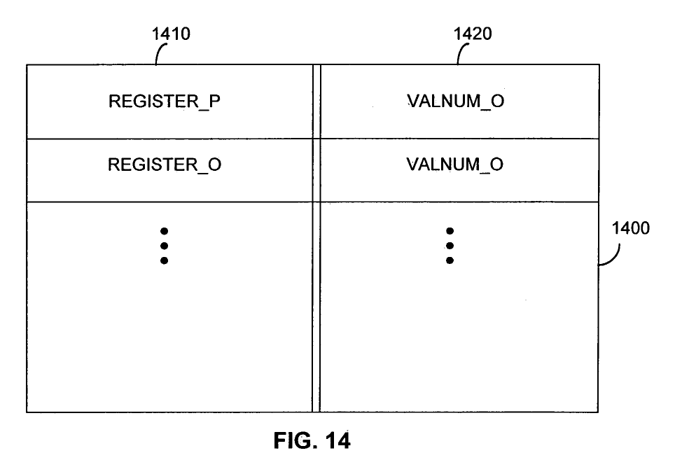

The byte-code sequence 1310 instructs the compiler to load the memory address of object o, e.g., from a hardware register or stack-frame slot, and store the loaded address into a register or stack-frame slot assigned to the variable p. The compiler then may equate the register or frame slot of the variable p with the value number assigned to the object o. To that end, the compiler may maintain a data structure, such as FIG. 14's table 1400, that maps memory locations (e.g., slot numbers and/or register numbers) with their equivalent value numbers. For example, in response to compiling the byte-code sequence 1310, the compiler may associate the register (“register_p”) of variable p in the column 1410 with the value number (“valnum_o”) of the object o in the column 1420. Similarly, the table 1400 includes an entry equating object o's memory location (“register_o”) with its value number, valnum_o.

Later, when compiling the sequence of byte-codes 1320, the byte codes instruct the compiler to load the memory addresses of object o and variable p, and store the memory address of object p into an object reference field located at an offset_f from the beginning of the object o. The offset_f may be specified in bytes, words, or other units compatible with the compiler-process. Conventionally, the compiler would emit a write barrier accompanying the reference-writing instruction corresponding to the byte-code sequence 1320. However, because the compiler previously equated variable p's location with object o's value number during the compilation of the byte-code sequence 1310, the compiler can determine the byte-code sequence 1320 corresponds to a “self-reference” instruction. Thus, in accordance with the illustrative embodiment, the compiler may elide the write-barrier code that previously would accompany the byte-code sequence 1320.

More specifically, when compiling the byte-code sequence 1320, the compiler may generate FIG. 12's exemplary Emit_WRITE compiler-function call 1230. The compiler-function call comprises arguments 1232 that identify a destination address and argument 1234 that identifies the location of the source value being copied into the destination address. The argument 1234 indicates the source value is stored in a register identified by register_p, and the compiler may look up entries in the table 1400 to determine whether a value number is associated with the register_p. Likewise, the compiler may refer to the table 1400 to identify the value number associated with the object whose memory address is stored in register_o. Preferably, the table is organized as a hash table, so the compiler may apply a hash function to register_p and register_o to generate indexes into the table. Alternatively, the table 1400 may be embodied as several tables. For example, a first table may map registers to value numbers, whereas a second table maps stack-frame slots to value numbers.

In this example, the result of the look-ups in table 1400 indicate that the register_p and register_o arguments in the compiler-function call 1230 are both assigned the same value number, namely valnum_o. Therefore, the compiler can determine, e.g., by direct comparison, that the source value identified by the register_p argument 1234 is equivalent to the memory address of the destination object identified by register_o in arguments 1232. In other words, by examining the arguments in the Emit_WRITE function call in the above-described manner, the compiler can identify that the compiled reference-writing instruction “o.f=p;” stores a self-reference in the object o, and, in accordance with the illustrative embodiment, the compiler does not include write-barrier code in the emitted object code (shown in its assembler-language representation), at step 1240.

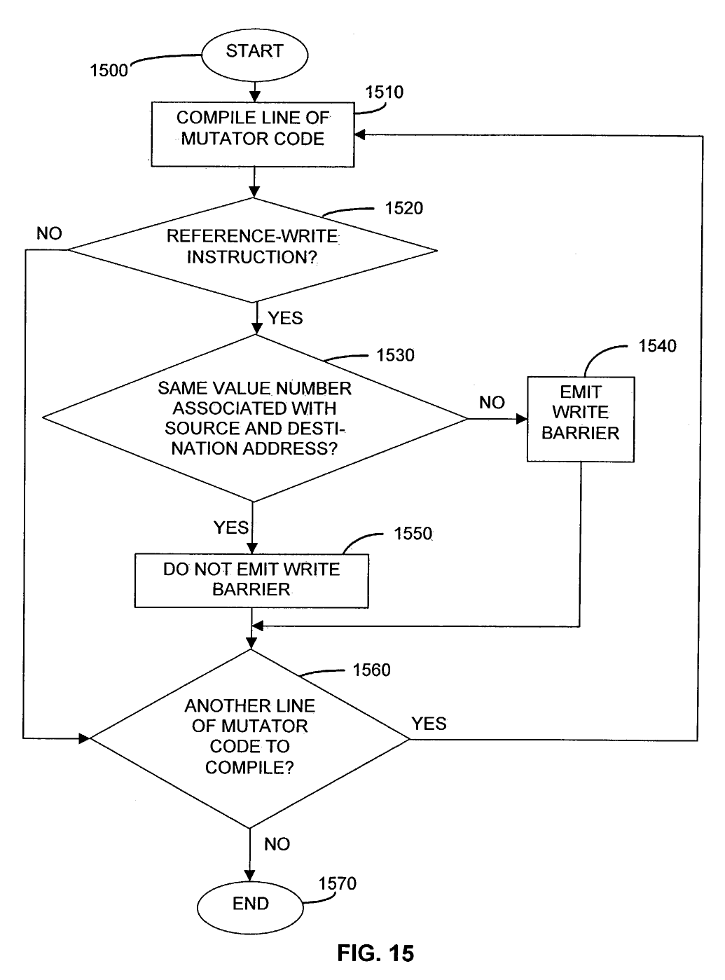

FIG. 15 illustrates a sequence of steps for compiling mutator code where the mutator code may include instructions to store self-references in an object's reference fields. The sequence starts at step 1500 and proceeds to step 1510, where a line of mutator code is compiled. Steps 1520-1550 analyze the line of mutator code to determine whether or not to emit a write barrier. Specifically, at step 1520, the compiler determines whether the compiled line modifies a reference in an object. If a reference is not modified, the sequence proceeds to step 1560. If a reference is modified, at step 1530 the compiler determines whether the destination address being modified is associated with the same value number as the memory address storing the source value written into the destination address. The compiler may make this determination by examining selected arguments passed to one or more compiler functions, such as an Emit_WRITE function. Those skilled in the art will appreciate that the compiler also may identify equivalent value numbers in other ways appropriate to the compiling process implemented.

If the source and destination addresses are associated with the same value number, then, at step 1550, no write barrier is emitted by the compiler in addition to the compiled line of mutator code. On the other hand, if the source and destination addresses are not associated with the same value number, then at step 1540 the compiler may emit a write barrier corresponding to the compiled reference-writing instruction—or it may determine whether some other elision criterion is satisfied. Next, at step 1560, the compiler determines whether there is another line of mutator code to compile. If there is another line, the sequence returns to step 1510. Otherwise, the sequence ends at step 1570.

C. Storing the Contents of an Object Reference Field Into Another Field Located in the Same Object or Card

According to the illustrative embodiment, when mutator code marks cards according to an imprecise -card-marking scheme, a compiler may omit a write barrier from the mutator code when a reference is copied from a first reference field to a second reference field in the same object. Notably, such mutator instructions are often employed in conventional swapping and sorting routines.

So long as the collector is aware that a referred-to object is reachable from the reference-containing object through that object's first reference field, it can properly judge the referred-to object's reachability without being made aware that the second reference field refers to that object, too. Of course, a subsequent change to the first reference field could make collector knowledge of the second reference field's contents necessary. But the collector will obtain that knowledge as a result of the write barrier that accompanies that subsequent modification: since the system uses imprecise card marking, the collector will scan all of the containing-object's fields, even if the write barrier was executed in response to only the modification of the first reference field. For this reason, the compiler may safely elide the write barrier corresponding to the reference-writing instruction that copies the reference value stored in the first reference field into the second reference field.

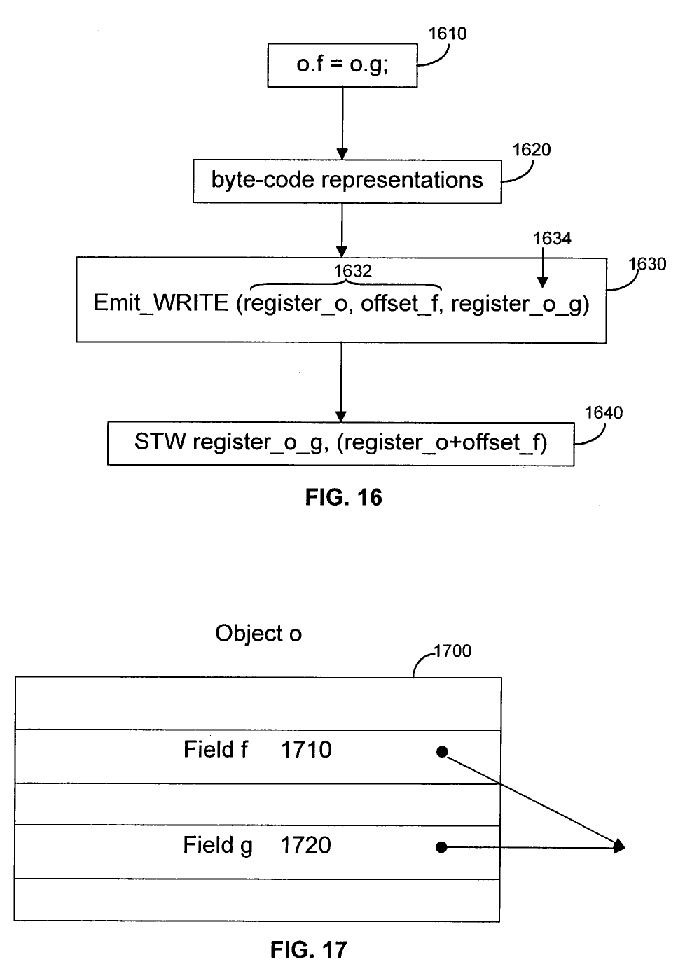

FIG. 16 depicts a sequence of steps for compiling an exemplary source-code instruction (“o.f=o.g;”) that stores the contents of one object reference field into another field in the same object. At step 1610, a field f of an object o is assigned the value stored in a field g of the same object o. The source-code is converted to its byte-code representation, at step 1620, and a compiler process, e.g., in a virtual machine, formulates a compiler-function call 1630 to generate machine-level code 1640 (shown in its assembler-language representation) that may be executed by a processor. The call 1630 comprises arguments 1632 that identify a destination address and argument 1634 that identifies a memory address containing a source value being copied into the destination address. As is in previous examples, register_o stores the starting address of object o and offset_f stores the relative offset of the field f in the object o. In this example, a temporary register register_o_g stores the memory address of a field g located at a relative offset of offset_g in the object o.

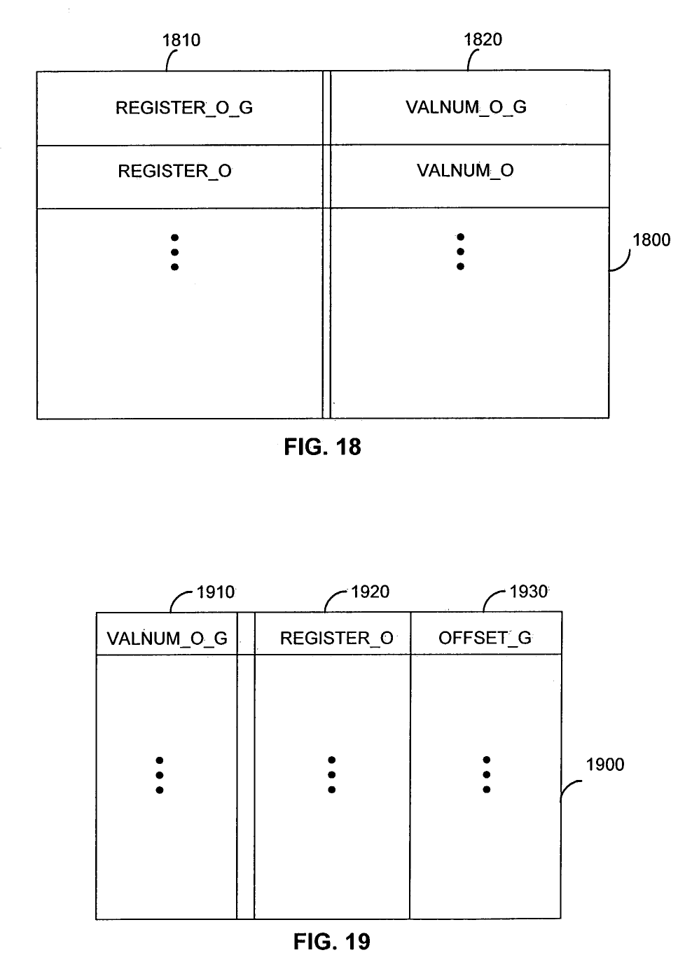

In operation, the compiler may assign a value number (“valnum_o_g”) to the 20 source value's memory location, stored in the temporary register register_o_g. A data structure, such as FIG. 18's table 1800, may be used by the compiler to associate registers (or frame slots) with their equivalent value numbers. As shown, registers identified in column 1810 are associated with value numbers identified in column 1820. For example, the table 1800 associates the registers register_o_g and register_o with their respective value numbers valnum_o_g and valnum_o. In addition, the compiler may rely on a separate data structure, such as FIG. 19's table 1900, to equate a value number stored in the column 1910 with its equivalent memory location, e.g., defined by a register (or frame slot) identified in the column 1920 and a relative offset identified in the column 1930. For instance, the table 1900 associates the value number valnum_o_g with the source address (“o.g”) defined by the memory address stored in register_o and the offset value off-set_g. Preferably, the tables 1800 and 1900 are organized as hash tables.

By examining the arguments 1632 and 1634 based on the contents of tables 1800 and 1900, the compiler can identify that the Emit_WRITE function call 1630 corresponds to an instruction that writes a value stored in a first reference field (“o.g”) into a different reference field (“o.f”) in the same object. More specifically, the compiler can look up the value numbers for register_o and register_o_g from the table 1800. Then, the compiler can further equate the value number register_o_g with the memory location defined by register_o and offset_g, based on the contents of the table 1900.

From the results of the above-described table look-ups, the compiler can determine that both the source value memory address identified in argument 1634 and the destination memory address identified in arguments 1632 are associated with the same value number (“valnum_o”) and are therefore located in the same object o. So the compiler does not emit corresponding write-barrier code in addition to the STW (“store is word”) instruction at step 1640. FIG. 17 illustrates the results of executing the object code corresponding to the assembly instruction 1640. Field f (1710) of object o (1700) stores the same reference value as that stored in field g (1720) in the object o.

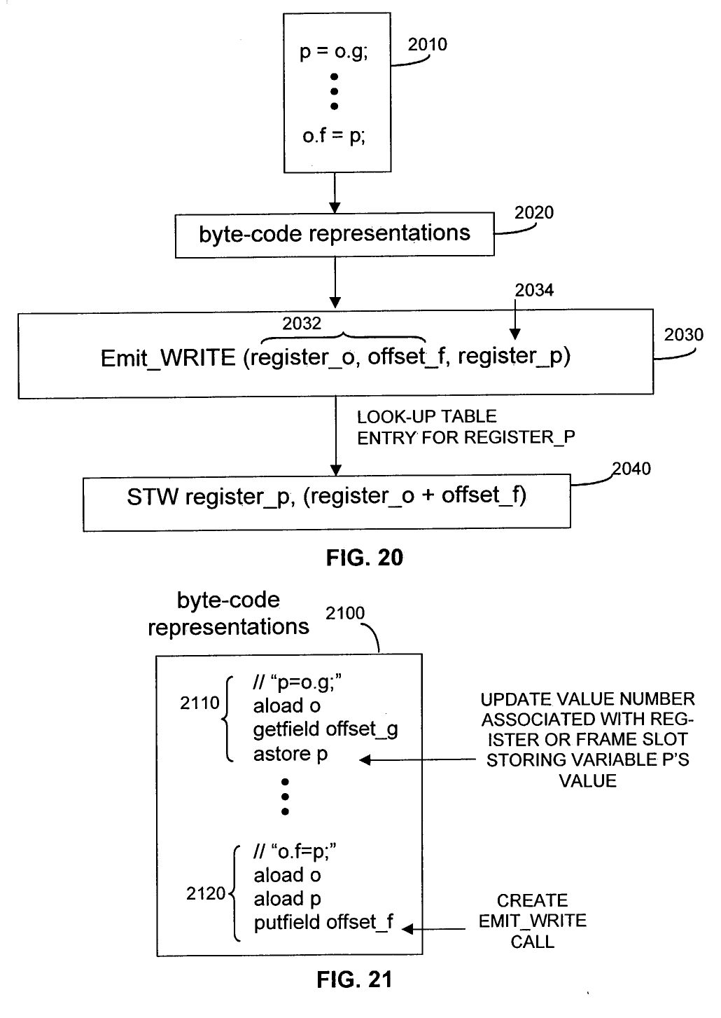

FIG. 20 illustrates another sequence of steps for compiling mutator instructions that store the value of a first reference field into a second reference field located in the same object. Source-code instructions, at step 2010, copy a reference value stored in a field g of an object o into a reference variable p (“p=o.g;”), then later store the contents of the variable p into a field f in object o (“o.f=p;”). These two instructions need not be consecutive and may be separated by other instructions in the mutator code. The source-code instructions are converted to their byte-code representations, at step 2020, and are transferred to a compiler process, e.g., in a virtual-machine. FIG. 21 illustrates FIG. 20's byte-code representations in more detail. Specifically, the exemplary byte-codes 2100 are shown as two sequences 2110 and 2120, respectively corresponding to the instructions “p=o.g;” and “o.f=p;.”

The byte-code sequence 2110 instructs the compiler to load the memory address of object o, e.g., from a hardware register or stack-frame slot, and store the contents of a reference field located offset_g from the beginning of the object o into a register or stack-frame slot assigned to the variable p. The compiler then may equate the register or stack-frame slot assigned to the variable p with the value number of the object o in which the field g is located. To that end, the compiler may maintain a data structure, such as FIG. 5 22's table 2200, that maps memory locations (e.g., slot numbers and register numbers) with corresponding value numbers. For example, in response to compiling the byte-code sequence 2110, the compiler may store the register (“register_p”) of variable p in the column 2210 so it may be mapped to the variable p's associated value number (“valnum_p”) stored in the column 2220. Similarly, the table includes an entry equating object o's memory location (“register_o”) with its value number (“valnum_o”). Preferably, the table 2200 is organized as a hash table.

In addition, the compiler may maintain a separate data structure, such as FIG. 23's table 2300, that maps value numbers to their equivalent expressions. For instance, in response to compiling the byte-code sequence 2110 for the source-code instruction “p=o.g;,” the compiler may store the value number of the variable p in the column 2310 so it may be mapped to the register containing the memory address of the object o (“register_o”) and the offset_g within object o, which are respectively stored in columns 2320 and 2330. Those skilled in the art will appreciate that the table may equate value numbers with expressions stored in terms of value numbers, such as “valnum_o” rather than explicit memory locations, such as “register_o,” as shown. Also, the table 2300 is preferably organized as a hash table.

When compiling the sequence of byte-codes 2120, the byte codes instruct the compiler to load the memory addresses of objects o and p, and store the memory address of the variable p into an object reference field located at an offset_f from the beginning of the object o. Notably, like the value of offset_g in sequence 2110, the value of offset_f may be specified in bytes, words, or other units compatible with the compiler-process. Conventionally, the compiler would emit a write barrier accompanying the reference-writing instruction corresponding to the byte-code sequence 2120. However, based on the information previously recorded by the compiler, e.g., in tables 2200 and 2300, the compiler can determine the byte-code sequence 2120 corresponds to an instruction that copies the contents of a first object reference field o.g into another field o.f in the same object.

More specifically, when compiling the byte-code sequence 2120, the compiler may make FIG. 20's exemplary Emit_WRITE compiler-function call 2030. The compiler-function call comprises arguments 2032 that identify a destination address and argument 2034 that identifies the location of the source value being copied into the destination address. In this exemplary compiler function call, the first two arguments indicate the destination address is located at an offset_f in the object whose address is stored in the register_o, and the last argument indicates the source value is stored in the register register_p. Based on the contents of table 2200, the compiler can equate register_p with its value number valnum_p, and similarly equate the register_o with its value number valnum_o. Furthermore, the compiler can retrieve an equivalent expression for valnum_p from the contents of table 2300.

In this example, the result of the look-up in table 2300 indicates that the valnum_p corresponds to a reference field located at an offset_g from the beginning of the object whose memory location is stored in register_o. In addition, the compiler can equate the register o with the valnum o by an appropriate look-up in the table 2200. Thus, the compiler can determine the source address in the call 2030 is located in the object whose value number equals valnum_o. As previously noted, the compiler also determined the destination address was located in -the object o assigned a value number equal to valnum_o.

Thus, by examining arguments in the Emit_WRITE call in the above-described manner, the compiler can recognize that the call corresponds to a mutator instruction that copies the contents of a first reference field (i.e., o.g) into a second reference field (i.e., o.f) located in the same object. So, in an imprecise card-marking scheme, the compiler may safely elide the write barrier that would conventionally accompany the emitted reference-writing instruction 2040 (shown in its assembler-language representation). Again, this is because subsequent modifications to the first or second reference fields in an imprecise card-marking scheme will result in the collector scanning the entire object, so the collector does not “lose” the information that would have been communicated by execution of the omitted write-barrier code.

When the collector is configured to scan references according to a precise card-marking scheme, the collector responds to a dirty-card indication by scanning every reference field in the marked card. According to the illustrative embodiment, if a reference is copied from a first reference field to a second reference field located in the same card, the compiler may safely elide the write barrier for the reference modification made to the second reference field. That is, execution of a write barrier corresponding to any subsequent modifications to the first reference field will result in the collector scanning all reference fields in the card, thereby notifying the collector of the previously unrecorded reference modification made to the second reference field. A compiler can conclude that the two reference fields reside on the same card if (i) they are located in the same object and (ii) their relative offsets in the object and the object's byte-alignment in a card assure the two fields are located in the same card.

Referring again to FIG. 20, when the compiler creates the Emit_WRITE call 2030, the compiler looks up valnum_p in the table 2300 to see if the value number is associated with any equivalent values or expressions. As previously described, the result of the look-up indicates that valnum_p corresponds to a reference field located at an offset_g from the beginning of an object whose value number equals valnum_o. Based on this information, the compiler in an imprecise card-marking scheme may elide a write barrier corresponding to the Emit_WRITE call because the source value is located in an object having the same value number (i.e., valnum_o) as the object in which the source value is stored.

In a precise card-marking scheme, the compiler must make an additional determination based on the information it retrieves from the table 2300 before a write barrier can be safely elided for the Emit_WRITE call 2030: the compiler must determine that the reference fields located at offset_f and offset_g in the object o are situated in the same card. In the illustrative embodiment, the compiler makes this determination based on a predetermined knowledge of objects' byte-alignment in the cards. For example, assuming objects and cards both begin on double-word boundaries, the compiler can determine that object fields in the same double-word must be located in the same card. Thus, if offset_f and offset_g correspond to fields in the same double-word, and objects are aligned along double-word boundaries, then the compiler can conclude that the two fields are located in the same card and thus the write barrier for the call 2030 may be safely elided.

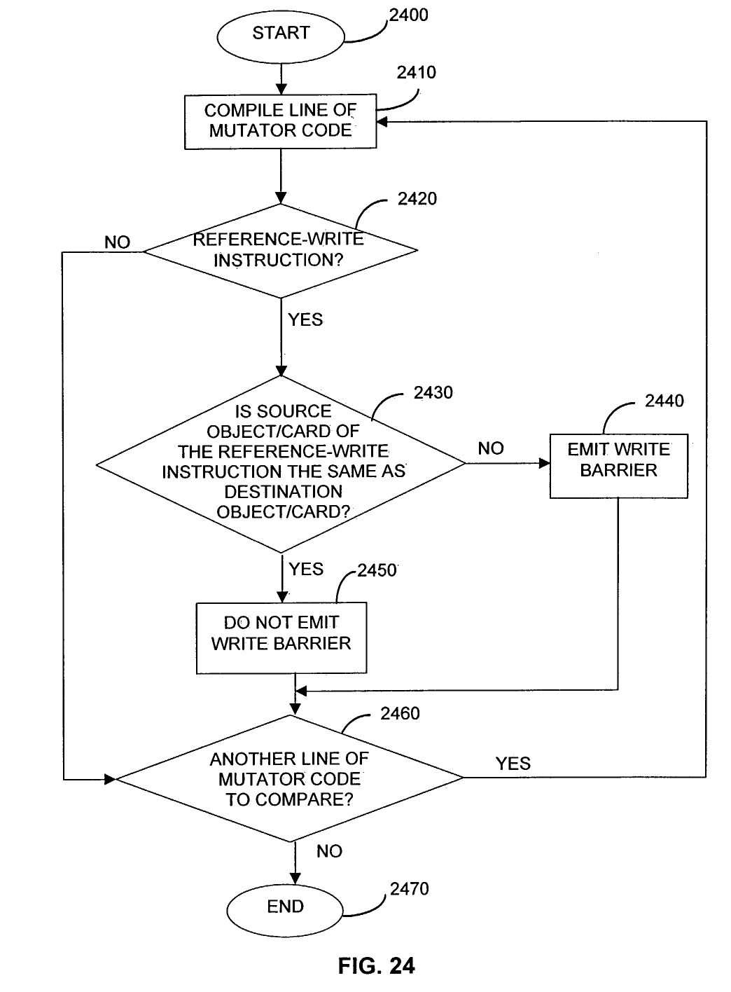

FIG. 24 is a flowchart illustrating a sequence of steps for compiling mutator code where the mutator code may include instructions that store references located in an object/card into different reference fields located in the same object/card. The sequence starts at step 2400 and proceeds to step 2410, where a line of mutator code is compiled. Steps 2420-2450 analyze the line of mutator code to determine whether or not to emit a write barrier. Specifically, at step 2420, the compiler determines whether the compiled line writes a reference into an object reference field. If a reference is not written into the field, the sequence proceeds to step 2460. If a reference is written into the field, at step 2430 the compiler determines whether the source object/card of the compiled instruction is the same as the destination object/card.

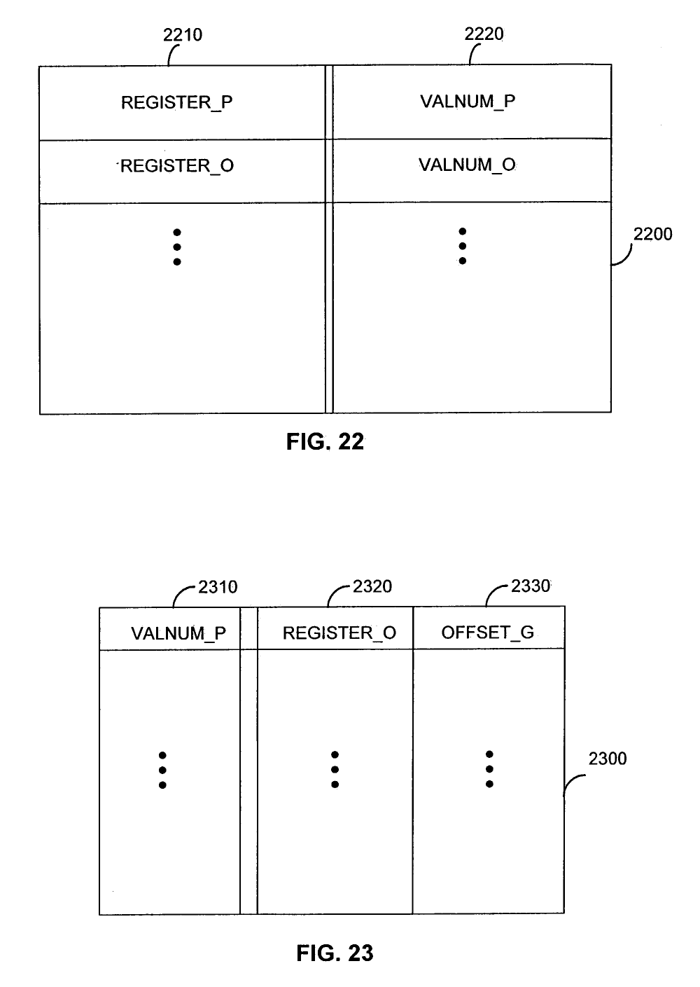

When write barriers are used to mark cards in an imprecise card-marking scheme, the compiler at step 2430 determines whether the mutator instruction stores a reference located in an object into another reference field located in the same object. When write barriers are used to mark cards in a precise card-marking scheme, the compiler at step 2430 determines whether the mutator instruction stores a reference located in a reference field into another field located in the same card. In either case, if the result of the determination at step 2430 is positive, then, at step 2450, no write barrier is emitted in addition to the compiled line of mutator code. The compiler may determine the source object/card is the same as the destination object/card, e.g., using the tables shown in FIGS. 22 and 23, or by any other manner appropriate to the compiler's implementation.

If the compiler determines the source object/card may be different than the destination object/card, the sequence proceeds to step 2440 where the compiler may emit a write barrier corresponding to the compiled reference-writing instruction. Next, at step 2460, the compiler determines whether there is another line of mutator code to compile. If there is another line, the sequence returns to step 2410. Otherwise, the sequence ends at step 2470.

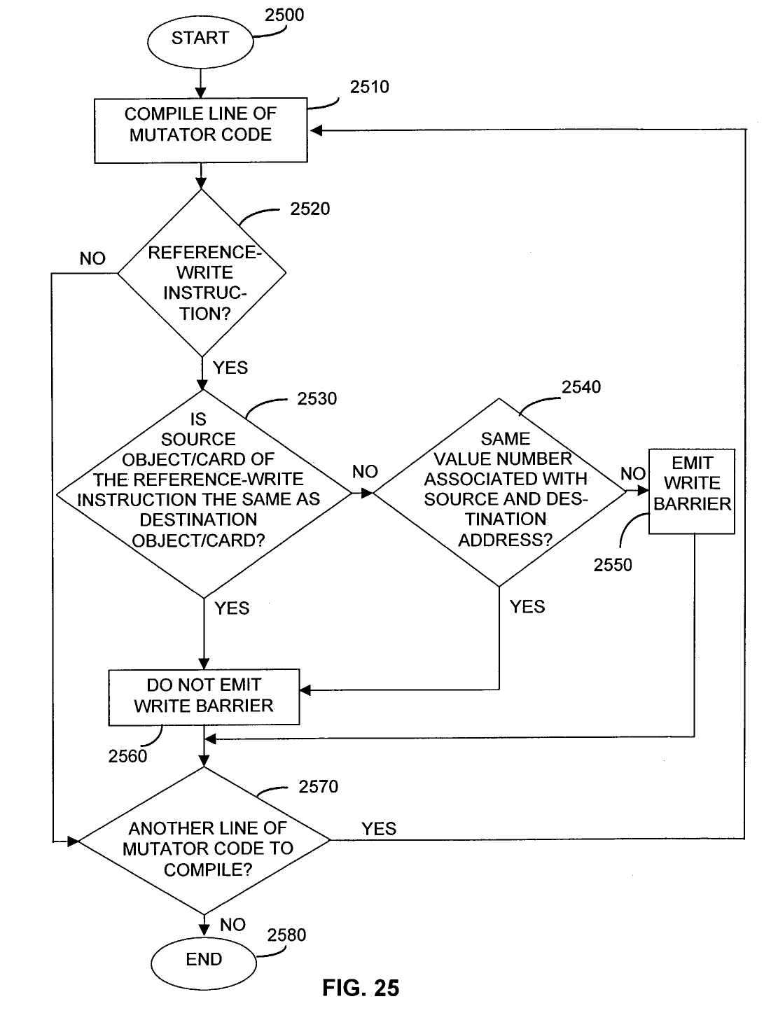

According to the illustrative embodiment, a compiler may apply any combination of the techniques described herein when determining whether to emit a write barrier for a compiled reference-writing mutator instruction. For example, FIG. 25 illustrates a sequence of steps that combines all of the elision criteria described in FIGS. 15 and 24. The sequence starts at step 2500 and proceeds to step 2510, where a line of mutator code is compiled. Steps 2520-2570 analyze the line of mutator code to determine whether or not to emit a write barrier. Specifically, at step 2520, the compiler determines whether the compiled line modifies a reference in an object. If a reference is not modified, the sequence proceeds to step 2580. If a reference is modified, at step 2530 the compiler tests whether the source object/card of the compiled instruction is the same as the destination object/card.

If the result of the determination at step 2530 is positive, then, at step 2560, no write barrier is emitted in addition to the compiled line of mutator code. If the compiler determines the source object/card is different than the destination object/card, the sequence proceeds to step 2540 where the compiler tests whether the same value number is associated with the source and destination addresses specified in the reference-write. If the value number associated with the source and destination addresses are the same, then, at step 2560, no write barrier is emitted by the compiler in addition to the compiled line of mutator code. Otherwise, the sequence proceeds to step 2550 where the compiler emits a write barrier corresponding to the compiled reference-writing mutator instruction. Next, at step 2570, the compiler determines whether there is another line of mutator code to compile. If there is another line, the sequence returns to step 2510. Otherwise, the sequence ends at step 2580.

D. Conclusion

The foregoing has been a detailed description of an illustrative embodiment of the invention. Various modifications and additions can be made without departing from the spirit and scope of the invention. For example, some concurrent-copying garbage collectors may rely on write barriers to stay synchronized with the mutator. Thus, when a concurrent-copying collector is implemented, the present invention may apply to only those reference-writing instructions that are not relied upon by the collector to stay in-sync with a mutator's execution. In addition, mutator instructions were described throughout the illustrative embodiment as being compiled before the compiler determines whether or not to emit their corresponding write barriers. However, the teachings set forth herein are equally applicable when the compiler determines whether or not to emit write barriers based on intermediate representations of the mutator instructions, such as their byte-code representations, or based on any other representations of the mutator's source code instructions.

While the exemplary compiler tests arguments in the compiler function Emit_WRITE against a set of one or more elision criterion, those skilled in the art will understand that the compiler may equivalently apply the elision criteria described herein to information located in other interpreting, compiling, runtime-system, and operating-system functions without departing from the spirit and scope of the present invention. Furthermore, compiler functions, such as Emit_WRITE, may take additional arguments besides those explicitly described herein depending on the particular compiler process implemented. Further, entries in the data structures shown in FIGS. 14, 18, 19, 22 and 23 may be filled in “on-the-fly” as described in the illustrative embodiment, although those skilled in the art will understand that the data structures may also be created before a run-time compilation process, e.g., and transferred to a virtual machine along with byte-code representations of the mutator code. Also, while the illustrative embodiment refers to write barriers that mark entries in a card-table, the teachings herein equally apply to write-barrier code that records information in other data structures, such as sequential-store buffers.

It is expressly contemplated that the teachings of this invention can be implemented as software, including a computer-readable medium having program instructions executing on a computer, hardware, firmware, or any combination thereof. The software may be embodied as electromagnetic signals by which computer instructions can be communicated. Accordingly this description is meant to be taken only by way of example and not to otherwise limit the scope of the invention.

What is claimed is:

1. For employing a computer to compile source code that specifies operation of a mutator that includes at least one reference-writing instruction into object code for execution by a computer system, which includes memory, together with a garbage collector that relies on the mutator's execution of write-barrier code to keep track of at least some reference modifications and operates in collection increments, in each of at least some of which it collects a respective collection set by reclaiming a portion of the memory that it determines to be occupied by objects that are no longer reachable, a method comprising:
(A) analyzing the source code to make a determination, for one of said at least one reference-writing instruction, whether that reference-writing instruction satisfies any elision criterion in a set of at least one elision criterion, where each criterion in said set of at least one elision criterion is satisfied only if execution of that reference-writing instruction will result in a heap state in which scanning the reference modified by that reference-writing instruction during any collection set's collection will not affect the garbage collector's ultimate determination of whether an object in that collection set is reachable; and
(B) generating object code that:
(i) directs the computer system to operate as the mutator;
(ii) includes that reference-writing instruction;
(iii) if said determination is negative, accompanies that reference-writing instruction with a write barrier that alerts the garbage collector to execution of the reference-writing instruction; and
(iv) if the result of said determination is affirmative, omits such a write barrier.

2. The method according to claim 1, wherein one criterion in said set of at least one elision criterion tests whether execution of said reference-writing instruction stores a self-reference in an object reference field.

3. The method according to claim 1, wherein at least one criterion in said set of at least one elision criterion depends on the garbage collector's region of summarization.

4. The method according to claim 3, wherein when the garbage collector's region of summarization is defined in accordance with an imprecise card-marking scheme, an elision criterion in said set of at least one elision criterion tests whether execution of said reference-writing instruction stores a source value located in an object into a destination address located in the same object.

5. The method according to claim 3, wherein when the garbage collector's region of summarization is defined in accordance with a precise card-marking scheme, an elision criterion in said set of at least one elision criterion tests whether execution of said reference-writing instruction stores a source value located in a card into a destination address located in the same card.

6. The method according to claim 5, wherein analyzing the source code to make said determination includes:
determining whether said source value and said destination address are located in the same object; and
determining a byte-alignment in the memory of said destination address and an object reference field storing said source value.

7. The method according to claim 4, wherein analyzing the source code to make said determination includes:
generating a table having one or more entries that map a memory location associated with an object or variable to a value number.

8. The method according to claim 5, wherein analyzing the source code to make said determination further includes:
generating a table having one or more entries that map a memory location associated with an object or variable to a value number; and
generating a table having one or more entries that map a value number to (i) a memory location or value number associated with an object and (ii) a relative offset within the object.
